(19) United States
(12) Patent Application Publication
(10) Pub. No.: US 2026/0166647 A1
(43) Pub. Date: Jun. 18, 2026

(54) LASER PROCESSING APPARATUS AND LASER PROCESSING METHOD

(71) Applicant: DISCO CORPORATION, Tokyo (JP)

(72) Inventors: Yasushi TANNO, Tokyo (JP); Hiroto YOSHIDA, Tokyo (JP)

(21) Appl. No.: 19/397,011

(22) Filed: Nov. 21, 2025

(30) Foreign Application Priority Data
Dec. 16, 2024 (JP) 2024-219720

(51) Int. Cl. B23K 26/06; B23K 26/042; B23K 101/40

(52) U.S. Cl. CPC B23K 26/0604; B23K 26/042; B23K 2101/40

(57) ABSTRACT

A laser processing apparatus configured to prevent adhesion of contaminants to an optical element, including: a workpiece holder that holds a workpiece; a laser irradiation assembly including a condenser applying a laser beam onto the workpiece held on the workpiece holder; an X-axis stage drive and a Y-axis stage which each relatively move the workpiece holder and the condenser. The laser irradiation assembly includes an optical component including: a chamber made of a non-magnetic material, constituted of a first end that receives light and a second end that emits light; a holder which holds an optical element to be housed in the chamber; a first magnet coupling connected to the holder; a second magnet coupling disposed outside the chamber and interlocking with the first magnet coupling; and a drive shaft connected to the second magnet coupling, and where the optical element is driven by rotation of the drive shaft.

### BACKGROUND

### 1. Technical Field

The present disclosure relates to a laser processing apparatus and a laser processing method.

### 2. Description of the Related Art

A wafer, on the front face of which a plurality of devices (e.g. ICs, LSIs) are formed by being sectioned along division lines, is thinned by grinding a rear face thereof, and is then divided into individual device chips by a dicing apparatus and a laser processing apparatus. The divided device chips are used for electric appliances such as a portable telephone and a personal computer.

The laser processing apparatus includes: a chuck table holding a wafer; a laser beam applying unit including a condenser applying a laser beam onto a wafer held on the chuck table; and a feeding unit feeding the chuck table and the condenser relatively to implement processing, so that the wafer can be processed at high precision (see JP 2008-290086 A, for example).

### SUMMARY

The laser beam applying unit of the laser processing apparatus includes: an oscillator which oscillates a laser beam; an attenuator which adjusts output of the laser beam oscillated by the oscillator; a beam expander which adjusts a beam diameter; and an optical axis adjusting unit which adjusts an optical axis of the laser beam of which output has been adjusted by the attenuator.

However if dust and dirt or contaminants such as grease splashed from peripheral structures adhere to optical elements (e.g. a ½ wave plate, ¼ wave plate, mirror, lens, beam splitter, prism, diffraction grating, and polarizer) constituting the attenuator, beam expander, optical axis adjusting unit and the like, then transmittance, reflectance and light quantity of the optical elements may drop, and vignetting of light may be caused by adhered substances, hence performance of optical elements may drop. In particular, with contaminants accumulating significantly in an area where light having high power density (e.g. laser beam) is irradiated, this contamination causes a drop in transmittance, reflectance and light quantity of optical elements, and drops performance of the optical elements.

It is an object of the present disclosure to provide a laser processing apparatus and a laser processing method that can prevent the adhesion of contaminants on optical elements.

According to the present disclosure, a following laser processing apparatus that solves the above problem is provided. In other words, provided is “a laser processing apparatus, including: a workpiece holder that holds a workpiece; a laser irradiation assembly including a condenser applying a laser beam onto the workpiece held on the workpiece holder; an X-axis stage drive that moves the workpiece holder and the condenser relatively to implement processing in an X axis direction; and a Y-axis stage drive that moves the workpiece holder and the condenser relatively to implement processing in a Y axis direction, which orthogonally intersects with the X axis direction. The laser irradiation assembly includes an optical component including: a chamber which is made of a non-magnetic material, constituted of a first end that receives light and a second end that emits light; a holder which holds an optical element to be housed in the chamber; a first magnet coupling which is connected to the holder; a second magnet coupling which is disposed outside the chamber and interlocks with the first magnet coupling; and a drive shaft which is connected to the second magnetic coupling. The optical element is driven by rotation of the drive shaft”.

It is preferable that the drive shaft includes a motor. It is preferable that the non-magnetic material includes aluminum, stainless steel, copper, brass, resin, glass or ceramics. An inside the chamber may be filled with dry air or inert gas containing nitrogen gas, or may be decompressed. It is preferable that each of the first end and the second end of the chamber includes a connecting portion so as to be connected to each other.

Further, according to the present disclosure, a following laser processing method to solve the above problem is provided. In other words, provided is “a laser processing method for dividing a wafer, which is a workpiece, into individual chips, the method including: preparing the above mentioned laser processing apparatus; causing a workpiece holder to hold the wafer; and laser processing of dividing the wafer into individual chips by applying a laser beam onto the wafer held on the workpiece holder”.

The laser processing apparatus of the present disclosure includes: a workpiece holder that holds a workpiece; a laser irradiation assembly including a condenser applying a laser beam onto the workpiece held on the workpiece holder; an X-axis stage drive that moves the workpiece holder and the condenser relatively to implement processing in an X axis direction; and a Y-axis stage drive that moves the workpiece holder and the condenser relatively to implement processing in a Y axis direction, which orthogonally intersects with the X axis direction. The laser irradiation assembly includes an optical component including: a chamber which is made of a non-magnetic material, constituted of a first end that receives light and a second end that emits light; a holder which holds an optical element to be housed in the chamber; a first magnet coupling which is connected to the holder; a second magnet coupling which is disposed outside the chamber and interlocks with the first magnet coupling; and a drive shaft which is connected to the second magnetic coupling, and the optical element is driven by rotation of the drive shaft. Therefore the optical element is insulated from the external environment, and the adhesion of contaminants to the optical element can be prevented. Hence the problem of a drop in performance of the optical element can be solved. Further, since the laser processing apparatus does not have a problem in a drop in performance of the optical element, failure rarely occurs, and service life is long.

The laser processing method of the present disclosure is a laser processing method for dividing a wafer, which is a workpiece, into individual chips, the method including: preparing the above mentioned laser processing apparatus; causing a workpiece holder to hold the wafer; and laser processing of dividing the wafer into individual chips by applying a laser beam onto the wafer held on the workpiece holder. Therefore the optical element is isolated from the external environment, and the adhesion of contaminants to the optical element can be prevented. Hence the problem of a drop in performance of the optical elements can be solved, and the wafer can be processed stably. Further, the above mentioned laser processing apparatus has a long service life since failure rarely occurs, therefore the unit price of the chips can be reduced.

### BRIEF DESCRIPTION OF THE DRAWINGS

FIG. 1 is a perspective view of a laser processing apparatus according to the present disclosure;

FIG. 2 is a perspective view of the laser irradiation assembly of the laser processing apparatus illustrated in FIG. 1;

FIG. 3A is an exploded perspective view of the first optical component illustrated in FIG. 2, and FIG. 3B is a perspective view of the first optical component illustrated in FIG. 3A;

FIG. 4A is an exploded perspective view of an attenuator including a second optical component illustrated in FIG. 2, and FIG. 4B is a perspective view of the attenuator illustrated in FIG. 4A;

FIG. 5A is an exploded perspective view of the second optical component illustrated in FIG. 2, and FIG. 5B is a perspective view of the second optical component illustrated in FIG. 5A;

FIG. 6 is a cross-sectional view of the second optical component illustrated in FIG. 2;

FIG. 7A is an exploded perspective view of the third optical component illustrated in FIG. 2, and FIG. 7B is a perspective view of the third optical component illustrated in FIG. 7A; and

FIG. 8A is an exploded perspective view of the fourth optical component illustrated in FIG. 2, and FIG. 8B is a perspective view of the fourth optical component illustrated in FIG. 8A.

### DESCRIPTION OF THE PREFERRED EMBODIMENTS

Preferred embodiments of the laser processing apparatus of the present disclosure will be described with reference to the drawings.

### Laser Processing Apparatus 2

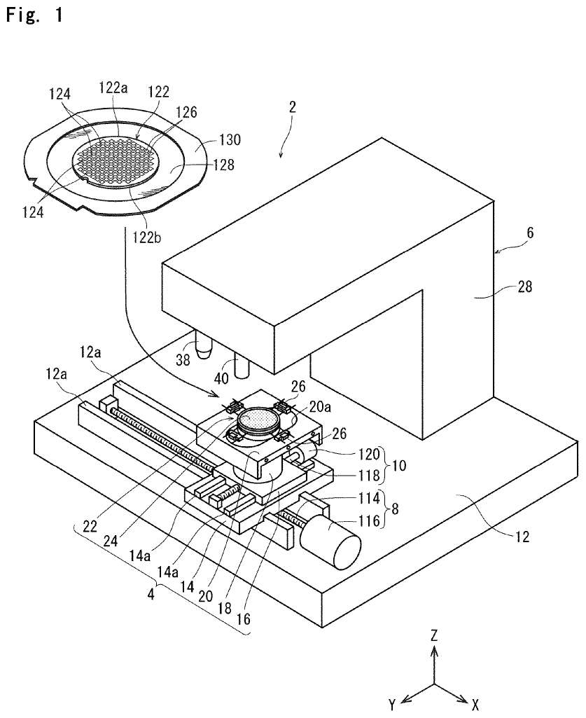

As illustrated in FIG. 1, the laser processing apparatus 2 includes: a workpiece holder 4 which holds a workpiece; a laser irradiation assembly 6 which includes a condenser to apply a laser beam onto the workpiece held on the workpiece holder 4; an X-axis stage drive 8 which feeds the workpiece holder 4 and the condenser relatively for processing in the X axis direction; and a Y-axis stage drive 10 which feeds the workpiece holder 4 and the condenser relatively for processing in a Y axis direction. The X axis direction is a direction which is indicated by the arrow X in FIG. 1, and the Y direction is a direction which is indicated by the arrow Y in FIG. 1 and which orthogonally intersects with the X axis direction. An XY plane defined by the X axis direction and the Y axis direction is substantially horizontal. A Z axis direction indicated by the arrow Z in FIG. 1 is a vertical direction which orthogonally intersects with the X axis direction and the Y axis direction. Dimensions, shapes and the like of the members illustrated in the drawings are exaggerated for explanatory purposes.

### Workpiece Holder 4 of Laser Processing Apparatus 2

The workpiece holder 4 includes: an X axis movable plate 14 which is supported on an upper face of a base 12 of the laser processing apparatus 2, so as to be movable in the X axis direction; a Y axis movable plate 16 which is supported on an upper face of the X axis movable plate 14, so as to be movable in the Y axis direction; a support 18 which is fixed on an upper face of the Y axis movable plate 16; and a cover plate 20 which is fixed at an upper end of the support 18. A long hole 20a which extends in the Y axis direction is formed on the cover plate 20, and a chuck table 22, which extends upward, is rotatably disposed at the upper end of the support 18 through the long hole 20a.

A disc-shaped suction chuck 24 is disposed at the upper end of the chuck table 22 of the workpiece holder 4. The suction chuck 24 is made of a porous member (e.g. porous ceramics), and is connected to a suction unit (not illustrated). The chuck table 22 generates a suction force on the upper face of the suction chuck 24 using the suction unit, and holds a workpiece placed on the upper face of the suction chuck 24 by suction. A plurality of clamps 26 are disposed on the periphery of the chuck table 22 at intervals in the circumferential direction.

### Laser Irradiation Assembly 6 of Laser Processing Apparatus 2

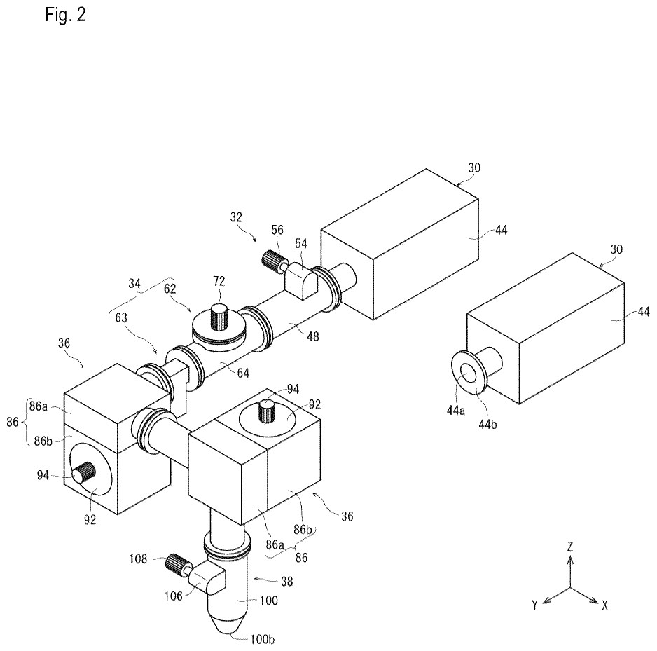

The laser irradiation assembly 6 includes a housing 28 which extends from the upper face of the base 12 upward, then extends substantially in the horizontal direction. As illustrated in FIG. 2, inside the housing 28, a laser oscillator 30, a first optical component 32 (beam expander), an attenuator 34 including a second optical component, a third optical component 36 (angle adjuster), and a fourth optical component 38 (condenser) are disposed. As illustrated in FIG. 1, on the lower face of the front end of the housing 28, an imaging unit 40, which images the workpiece and detects a target region of the laser processing, is disposed at an interval from the fourth optical component 38 (condenser) in the X axis direction.

### Laser Oscillator 30 of Laser Irradiation Assembly 6

The laser oscillator 30 includes a laser light source (not illustrated) which oscillates a laser beam LB, and a chamber 44 which covers the laser light source to isolate it from the external environment. The chamber 44 includes an emitting end 44a which emits the laser beam LB oscillated by the laser light source. A connecting portion 44b, which is constituted of an annular flange, for example, is disposed at the emitting end 44a.

### First Optical Component 32 of Laser Irradiation Assembly 6

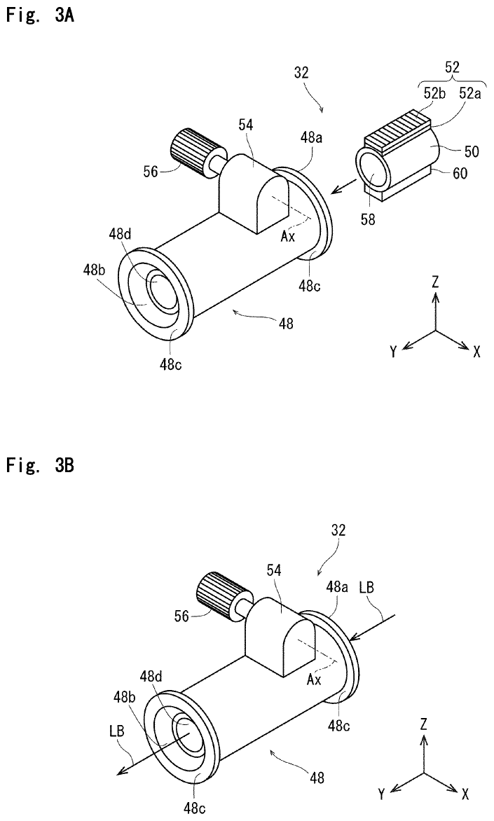

The first optical component 32 functions as a beam expander, which adjusts a beam diameter of the laser beam LB oscillated by the laser oscillator 30. As illustrated in FIGS. 3A and 3B, the first optical component 32 includes a chamber 48, a holder 50, a first magnet coupling 52, a housing 54 which houses a second magnet coupling (not illustrated), and a drive shaft 56.

### Chamber 48 of First Optical Component 32

The chamber 48 includes a first end 48a to receive light, and a second end 48b to emit light. The chamber 48 is cylindrical and is made of a non-magnetic material. The non-magnetic material, to form the chamber 48, may include aluminum, stainless steel, copper, brass, resin, glass or ceramics. The optical path in the chamber 48 is set from the first end 48a to the second end 48b along the shaft direction (Y axis direction) of the chamber 48. The first end 48a and the second end 48b include a connecting portion 48c respectively, which can be connected to the connecting portion 44b of the laser oscillator 30 via a fastening member, such as a bolt and a clamp band. A seal member (not illustrated), such as an O-ring and a gasket, is disposed between the connecting portion 44b and the connecting portion 48c. A pair of guide grooves (not illustrated), which extend in the Y axis direction, are formed on the inner peripheral surface of the chamber 48, and a lens 48d is fixed on the second end 48b side.

### Holder 50 of First Optical Component 32

The holder 50 holds an optical element 58 housed in the chamber 48. The holder 50 is cylindrical and is made of a non-magnetic material. The optical element 58 is a lens (movable lens) which adjusts the beam diameter of the laser beam LB in collaboration with the lens 48d (fixed lens) of the chamber 48, and is fixed inside the holder 50. The holder 50 is housed inside the chamber 48 via a non-magnetic guide bearing 60, so as to be movable in the Y axis direction. The guide bearing 60 is attached to the outer peripheral surface of the holder 50, and slidably interfits with a first guide groove of the chamber 48.

### First Magnet Coupling 52 of First Optical Component 32

The first magnet coupling 52 is connected to the holder 50. The first magnet coupling 52 has a rectangular shape which extends in the Y axis direction, and slidably fits into a second guide groove of the chamber 48. The first magnet coupling 52 includes a non-magnetic substrate 52a which is attached to the outer peripheral surface of the holder 50, and a magnet 52b which is attached to the outer surface of the substrate 52a. In the magnet 52b, an N-pole and an S-pole are alternately magnetized in the Y axis direction. Also in the magnet 52b, a plurality of magnets may be aligned in the Y axis direction.

### Second Magnet Coupling of First Optical Component 32

The second magnet coupling is disposed outside the chamber 48, and interlocks with the first magnet coupling 52. The second magnet coupling is cylindrical, and is housed in the non-magnetic housing 54, so as to be rotatable around the shaft line Ax, which extends in the X axis direction. The N-pole and the S-pole of magnet of the second magnet coupling are alternately disposed in the circumferential direction. The housing 54 is attached to the outer peripheral surface of the chamber 48, and a partition member (not illustrated) is disposed between the housing 54 and the chamber 48. This portion member prevents entry of foreign substances or the like to the first magnet coupling 52 side (inside the chamber 48) from the second magnet coupling side.

### Drive Shaft 56 of First Optical Component 32

The drive shaft 56 is connected to the second magnet coupling. The drive shaft 56 is made of a non-magnetic material. The drive shaft 56 may include a motor (e.g. pulse motor) to rotate the drive shaft 56. The drive shaft 56 may be manually rotated around the shaft line Ax.

In the first optical component 32, the second magnet coupling which is connected to the drive shaft 56 is rotated around the shaft line Ax by the drive shaft 56 rotating around the shaft line Ax. Then the first magnet coupling 52 moves in the Y axis direction by attraction/repulsion between the magnet of the second magnet coupling and the magnet 52b of the first magnet coupling 52. Thereby the holder 50, which is connected to the first magnet coupling 52, and the optical element 58 which is held by the holder 50, move in the Y axis direction. As a result, the beam diameter of the laser beam LB, which enters from the first end 48a of the chamber 48 and is emitted from the second end 48b thereof, is adjusted. In other words, in the first optical component 32, even if the optical element 58 is isolated from the external environment by the chamber 48, the beam diameter of the laser beam LB can be adjusted by rotating the drive shaft 56 and moving the optical element 58 in the Y axis direction thereby.

### Attenuator 34 of Laser Irradiation Assembly 6

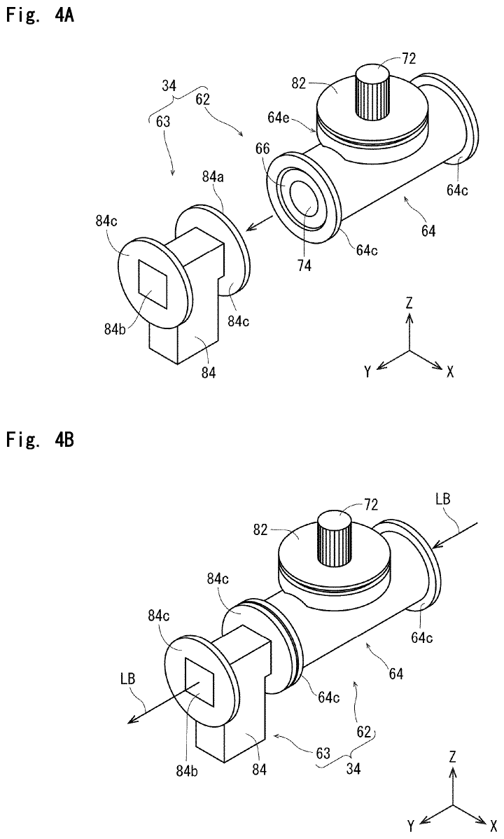

The attenuator 34 adjusts the output of the laser beam LB, of which beam diameter was adjusted by the first optical component 32. As illustrated in FIGS. 4A and 4B, the attenuator 34 includes a second optical component 62 and an additional optical component 63.

### Second Optical Component 62 of Attenuator 34

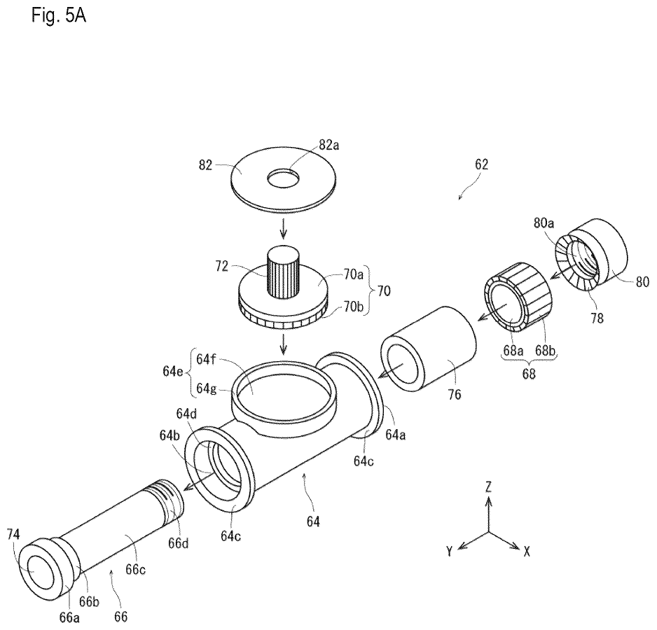

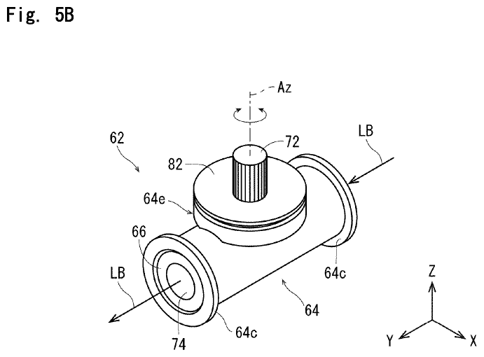

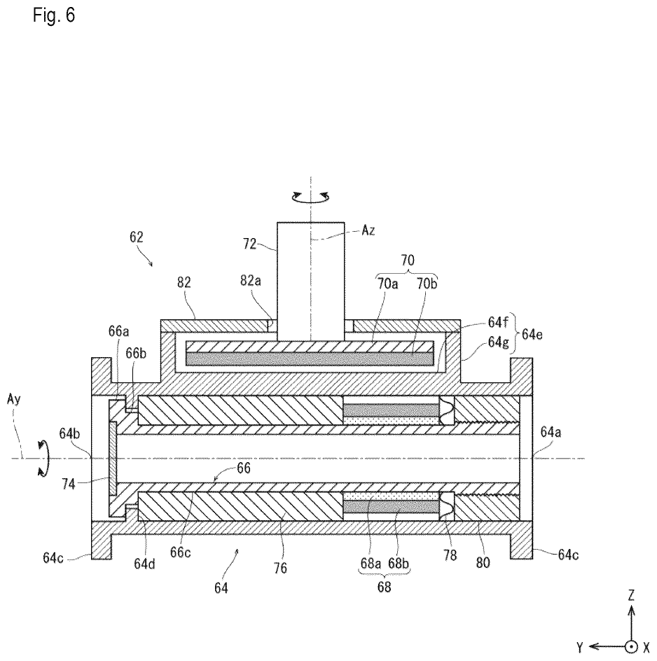

As illustrated in FIGS. 5A, 5B and FIG. 6, the second optical component 62 includes a chamber 64, a holder 66, first magnet coupling 68, a second magnet coupling 70, and a drive shaft 72.

### Chamber 64 of Second Optical Component 62)

The chamber 64 includes a first end 64a to receive light, and a second end 64b to emit light. The chamber 64 is cylindrical, and is made of a non-magnetic material. The optical path in the chamber 64 is set from the first end 64a to the second end 64b along the shaft direction (Y axis direction) of the chamber 64. The first end 64a and the second end 64b of the chamber 64 include a connecting portion 64c respectively, which can be connected to the connecting portion 48c of the first optical component 32. A seal member (not illustrated), such as an O-ring and a gasket, is disposed between the connecting portion 48c and the connecting portion 64c. As illustrated in FIG. 6, an inner diameter of the chamber 64 is approximately constant, and an annular protrusion 64d, which protrudes inward in the diameter direction, is formed on the inner peripheral surface of the chamber 64 on the second end 64b side.

A positioning portion 64e, at which the second magnet coupling 70 is positioned, is disposed on the outer surface of the chamber 64. The positioning portion 64e includes a circular partition wall 64f, which is disposed on the outer peripheral surface of the chamber 64, and an annular side wall 64g, which protrudes from the peripheral edge of the partition wall 64f. The positioning portion 64e is closed air tight, so that foreign substances and the like do not enter the chamber 64 through the positioning portion 64e.

### Holder 66 of Second Optical Component 62

The holder 66 holds an optical element 74 which is housed in the chamber 64. The holder 66 is cylindrical, and is made of a non-magnetic material. The optical element 74 is fixed at one end of the holder 66 in the shaft direction. In this embodiment, a ½ wave plate is fixed as the optical element 74, but the optical element 74 is not limited to the ½ wave plate, but may be a ¼ wave plate, a polarizing plate, a diffraction grating, a wedge prism, or the like. The holder 66 includes a first portion 66a in which the optical element 74 is fixed, a second portion 66b of which diameter is smaller than the first portion 66a, and a third portion 66c of which diameter is smaller than the second portion 66b. A male screw 66d is disposed on the front end of the third portion 66c (an end opposite side of the end in which the optical element 74 is fixed) (see FIG. 5A). When the holder 66 is housed in the chamber 64, as illustrated in FIG. 6, the first portion 66a of the holder 66 and the annular protrusion 64d of the chamber 64 contact, whereby the holder 66 is positioned at a predetermined position in the chamber 64.

The holder 66 is housed in the chamber 64 via a non-magnetic bearing 76, so as to be rotatable around the shaft line Ay (see FIG. 6), which extends along the Y axis direction. The bearing 76 may be a sliding bearing or a rolling bearing. As illustrated in FIG. 6, the Y axis direction position of the bearing 76 is set such that the end of the bearing 76 in the Y axis direction (left side end in FIG. 6) contacts the second portion 66b of the holder 66. In the Y axis direction, about a several μm gap exists between the bearing 76 and the annular protrusion 64d of the chamber 64.

### First Magnet Coupling 68 of Second Optical Component 62

The first magnet coupling 68 is connected to the holder 66. The first magnet coupling 68 includes a cylindrical interfitting portion 68a, which is made of a non-magnetic material, and a cylindrical magnet 68b, which is attached to the outer peripheral surface of the interfitting portion 68a. In the magnet 68b, an N-pole and S-pole are alternately magnetized in the circumferential direction. The magnet 68b may be formed of a plurality of magnets aligned in the circumferential direction, and be attached to the interfitting portion 68a in this state. When the first magnet coupling 68 is connected to the holder 66, the inner peripheral surface of the interfitting portion 68a is fitted to the outer peripheral surface of the holder 66, then an annular plate spring 78 and a cylindrical fixing unit 80 are attached to the holder 66. Then the bearing 76 and the first magnet coupling 68 are closely contacted by the annular plate spring 78, and the end of the bearing 76 is closely contacted with the side face of the second portion 66b of the holder 66. A female screw 80a is formed on the inner peripheral surface of the cylindrical fixing unit 80, and the fixing unit 80 is attached to the holder 66 by the female screw 80a of the fixing unit 80 engaging with the male screw 66d of the holder 66. The plate spring 78 and the fixing unit 80 are made of a non-magnetic material.

### Second Magnet Coupling 70 of Second Optical Component 62

The second magnet coupling 70 is disposed outside the chamber 64, and interlocks with the first magnet coupling 68. The second magnet coupling 70 includes a circular substrate 70a made of a non-magnetic material, and a disc-shaped magnet 70b, which is attached to the lower face of the substrate 70a. The N-pole and the S-pole of the magnet 70b radially extend from the center of the magnet 70b, and are disposed alternately in the circumferential direction. The second magnet coupling 70 is supported by a bracket (not illustrated), which is rotatable around the shaft line Az which extends in the Z axis direction, and is located at the positioning portion 64e of the chamber 64. The second magnet coupling 70 located at the positioning portion 64e is covered by a non-magnetic cover 82. A through hole 82a, for the shaft 72 to penetrate, is formed at the center of the cover 82.

The focus of the first and second magnet couplings 68 and 70 are not limited to the above embodiments, but may have various forms. For example, for the relationship of the shaft lines of the first and second magnet couplings 68 and 70, the shaft line Ay of the first magnet coupling 68 intersects orthogonally with the shaft line Az of the second magnet coupling 70 in this embodiment, but the shaft lines of the first and second magnet couplings 68 and 70 may be parallel. Further, the shape of the second magnet coupling 70 is disk-shaped in this embodiment, but may be cylindrical where the N-pole and S-pole are alternately magnetized in the circumferential direction.

### Drive Shaft 72 of Second Optical Component 62

The drive shaft 72 is connected to the second magnet coupling 70. Specifically, the drive shaft 72 is fixed to the upper face of the substate 70a of the second magnet coupling 70. The drive shaft 72 may include a motor (e.g. pulse motor) that rotates the drive shaft 72, although this is not illustrated. The drive shaft 72 may be rotated manually around the shaft line Az. The drive shaft 72 is made of a non-magnetic material.

In the second optical component 62, the second magnet coupling 70 which is connected to the drive shaft 72 is rotated around the shaft line Az by the drive shaft 72 rotating around the shaft line Az. Then the first magnet coupling 68 rotates around the shaft line Ay by attraction/repulsion between the magnet 70b of the second magnet coupling 70 and the magnet 68b of the first magnet coupling 68. Thereby the holder 66 which is connected to the first magnet coupling 68, and the optical element 74 which is held by the holder 66, rotate around the shaft line Ay. As a result, a rotation angle of the optical element 74, through which the laser beam LB passes, is adjusted. Thus in the second optical component 62, even if the optical element 74 is isolated from the external environment by the chamber 64, the drive shaft 72 can rotate around the shaft line Az, whereby the optical element 74 can be rotary-driven around the shaft line Ay.

Additional Optical Component 63 of Attenuator 34

As illustrated in FIGS. 4A and 4B, a chamber 84 of the additional optical component 63 includes a first end 84a to receive light, and a second end 84b to emit light. The first end 84a and the second end 84b include a connecting portion 84c respectively, which can be connected to the connecting portion 64c of the second optical component 62. A seal member (not illustrated), such as an O-ring and a gasket, is disposed between the connecting portion 64c and the connecting portion 84c. Inside the chamber 84, a damper (not illustrated) which absorbs light, and a beam splitter (not illustrated) which splits the light that entered from the first end 84a, and guides the light to the second end 84b and also to the damper, are disposed. The beam splitter may be either a plate type or a cube type.

For the laser beam LB, which entered from the first end 64a into the chamber 64 of the second optical component 62, the quantity of P-polarized light and quantity of S-polarized light are adjusted by the optical element 74 (½ wave plate) for the beam splitter of the additional optical component 63. Then this laser beam LB enters into the chamber 84 of the additional optical component 63 from the first end 84a. Out of the laser beam LB that entered the additional optical component 63, the P-polarized light transmits through the beam splitter and is emitted from the second end 84b of the chamber 84, and the S-polarized light is reflected by the beam splitter, and is guided to and absorbed by the damper. Then in the attenuator 34, the optical element 74 (½ wave plate) is rotated by rotating the drive shaft 72 of the second optical component 62, whereby the ratio of the P-polarized light (ratio of light emitted from the second end 84b) can be adjusted. Thus the attenuator 34 adjusts the output of the laser beam LB which entered the second optical component 62, and emits the adjusted laser beam LB from the additional optical component 63.

In the chamber 84 of the additional optical component 63, a third end (not illustrated), to emit the S-polarized light which was reflected by the beam splitter, may be disposed instead of the damper. In this case, the laser beam LB which entered the second optical component 62 can be split into P-polarized light and S-polarized light at an appropriate ratio, whereby the P-polarized light can be emitted from the second end 84b of the chamber 84 of the additional optical component 63, and the S-polarized light can be emitted from the third end of the chamber 84. In other words, instead of the attenuator 34 for adjusting the output of the laser beam LB, a splitting unit, for splitting the laser beam LB at an appropriate ratio, can be configured.

### Third Optical Component 36 of Laser Irradiation Assembly 6

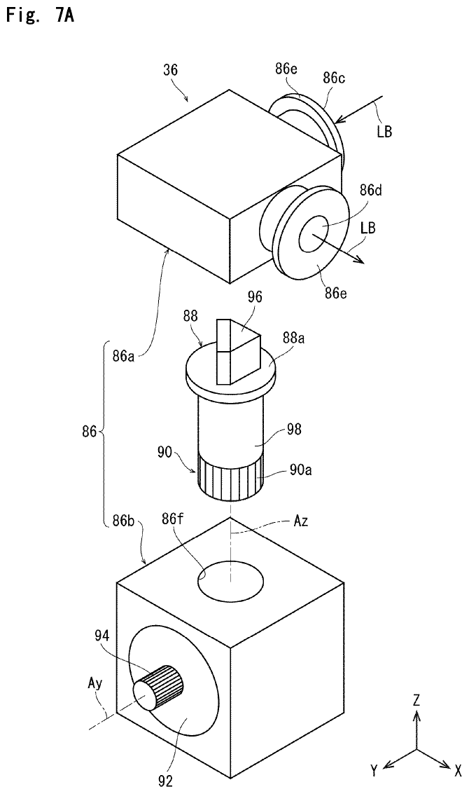

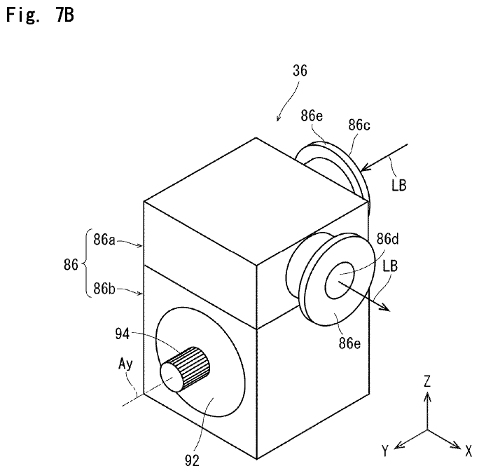

The third optical component 36 is configured to be an angle adjuster, which adjusts the angle of the optical path of the laser beam LB of which output has been adjusted by the attenuator 34. As illustrated in FIGS. 7A and 7B, the third optical component 36 includes a chamber 86, a holder 88, a first magnet coupling 90, a housing 92 which houses a second magnet coupling (not illustrated), and a drive shaft 94.

### Chamber 86 of Third Optical Component 36

The chamber 86 includes a non-magnetic upper chamber 86a, and a non-magnetic lower chamber 86b which is connected to a lower face of the upper chamber 86a.

### Upper Chamber 86a

The upper chamber 86a includes a first end 86c to receive light, and a second end 86d to emit light. The optical path inside the upper chamber 86a is set such that the laser beam LB, which entered from the first end 86c along the Y axis direction, is emitted from the second end 86d along the X axis direction. The first end 86c and the second end 86d includes a connecting portion 86e respectively, which can be connected to the connecting portion 84c of the additional optical component 63 of the attenuator 34. A seal member (not illustrated), such as an O-ring and a gasket, is disposed between the connecting portion 84c and the connecting portion 86e.

### Lower Chamber 86b

The lower chamber 86b is connected air tight to the lower face of the upper chamber 86a. Therefore foreign substances and the like do not enter the chamber 86 through the gap between the upper chamber 86a and the lower chamber 86b. As illustrated in FIG. 7A, a housing hole 86f is formed on the upper face of the lower chamber 86b, so as to house the first magnet coupling 90. The second magnet coupling is connected to the lower chamber 86b as described above, and a partition member (not illustrated) is disposed between the second magnet coupling and the first magnet coupling 90. This partition member of the lower chamber 86b prevents entry of foreign substances or the like to the first magnet coupling 90 side (inside the chamber 86) from the second magnet coupling side.

### Holder 88 of Third Optical Component 36

The holder 88 holds an optical element 96 to be housed in the upper chamber 86a. The holder 88, which is made of non-magnetic material, includes a disc-shaped main portion 88a, and a cylindrical portion (not illustrated) which extends downward from a lower face of the main portion 88a. The optical element 96 is a prism mirror which reflects the laser beam LB which entered from the first end 86c to the upper chamber 86a, and guides the laser beam LB to the second end 86d, and is fixed to an upper face of the main portion 88a of the holder 88. The optical element 96 may be a plate-shaped mirror. The holder 88 is housed in the chamber 86 via a non-magnetic bearing 98, to be rotatable around the shaft line Az which extends along the Z axis direction. The bearing 98 is attached to the cylindrical portion of the holder 88, and rotatably interfits with the housing hole 86f of the lower chamber 86b.

### First Magnet Coupling 90 of Third Optical Component 36

The first magnet coupling 90 is connected to the holder 88. The first magnet coupling 90 includes a cylindrical-shaped connecting portion (not illustrated), which is fixed to the cylindrical portion of the holder 88, and a cylindrical-shaped magnet 90a, which is attached to the outer peripheral surface of the connecting portion. In the magnet 90a, the N-pole and S-pole are alternately magnetized in the circumferential direction. The magnet 90a may be formed of a plurality of magnets aligned in the circumferential direction, and attached to the connecting portion.

### Second Magnet Coupling of Third Optical Component 36

The second magnet coupling is disposed outside the upper chamber 86a, and interlocks with the first magnet coupling 90. The second magnet coupling is cylindrical or disc-shaped, and is housed in the non-magnetic housing 92 to be rotatable around the shaft line Ay, which extends in the Y axis direction. The N-pole and S-pole of the magnet of the second magnet coupling are alternately disposed in the circumferential direction. The housing 92 is attached to the lower chamber 86b.

The forms of the first magnet coupling 90 and the second magnet coupling are not limited to the above embodiment, but may have various different forms. For example, for the relationship between the shaft lines of the first magnet coupling 90 and the second magnet coupling, the shaft line Az of the first magnet coupling 90 intersects orthogonally with the shaft line Ay of the second magnet coupling in this embodiment, but the shaft lines of the first magnet coupling 90 and the second magnet coupling may be parallel.

### Drive Shaft 94 of Third Optical Component 36

The drive shaft 94 is connected to the second magnet coupling. The drive shaft 94 may include a motor (e.g. pulse motor) that rotates the drive shaft 94, although this is not illustrated. The drive shaft 94 may be rotated manually around the shaft line Az. The drive shaft 94 is made of a non-magnetic material.

In the third optical component 36, the second magnet coupling which is connected to the drive shaft 94 is rotated around the shaft line Ay by the drive shaft 94 rotating around the shaft line Ay. Then the first magnet coupling 90 rotates around the shaft line Az by attraction/repulsion between the magnet of the second magnet coupling and the magnet 90a of the first magnet coupling 90. Thereby the holder 88, which is connected to the first magnet coupling 90, and the optical element 96 which is held by the holder 88, rotate around the shaft line Az. As a result, the angle of the optical path of the laser beam LB, which enters from the first end 86c of the upper chamber 86a and is emitted from the second end 86d, is adjusted. In other words, in the third optical component 36, even if the optical element 96 is isolated from the external environment by the chamber 86, the drive shaft 94 can rotate around the shaft line Ay, whereby the optical element 96 can be rotary-driven around the shaft line Az, and the angle of the optical path of the laser beam LB can be adjusted thereby.

### Fourth Optical Component 38 of Laser Irradiation Assembly 6

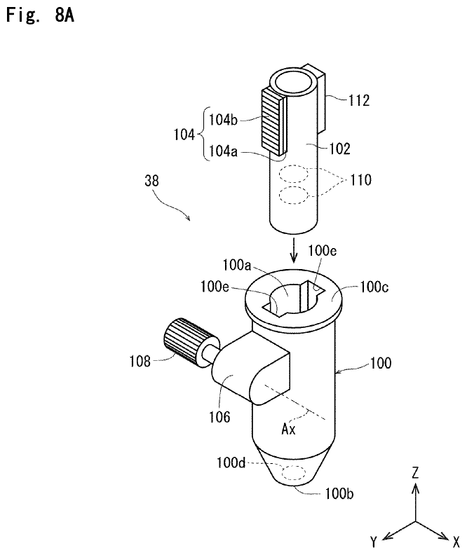

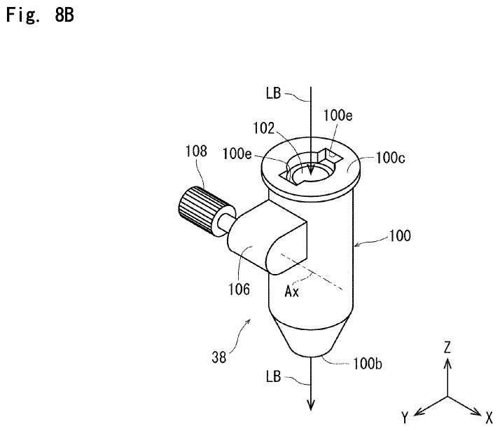

The fourth optical component 38 is configured to be a condenser, which condenses the laser beam LB of which angle of the optical path has been adjusted by the third optical component 36. As illustrated in FIGS. 8A and 8B, the fourth optical component 38 includes a chamber 100, a holder 102, a first magnet coupling 104, a housing 106 which houses a second magnet coupling (not illustrated), and a drive shaft 108.

### Chamber 100 of Fourth Optical Component 38

The chamber 100 includes a first end 100a to receive light, and a second end 100b to emit light. The chamber 100 is cylindrical and is made of a non-magnetic material. The optical path in the chamber 100 is set from the first end 100a to the second end 100b along the shaft direction (Z direction) of the chamber 100. The first end 100a includes a connecting portion 100c, which can be connected to the connecting portion 86e of the third optical component 36. A seal member (not illustrated), such as an O-ring and a gasket, is disposed between the connecting portion 86e and the connecting portion 100c. On the second end 100b, on the other hand, a connecting portion is not disposed, but a cover glass 100d, to prevent foreign substances from entering the chamber 100, is attached. A pair of guide grooves 100e, which extend in the Z axis direction, are formed on the inner peripheral surface of the chamber 100.

### Holder 102 of Fourth Optical Component 38

The holder 102 holds an optical element 110 housed in the chamber 100. The holder 102 is cylindrical and made of a non-magnetic material. The optical element 110 is a plurality of lenses (group lens) that condense the laser beam LB, and is fixed inside the holder 102. In FIG. 8A, for simplicity two lenses are illustrated as the optical element 110, but a number of lenses of the optical element 110 may be freely set. The holder 102 is housed inside the chamber 100 via a non-magnetic guide bearing 112, so as to be movable (elevatable) in the Z axis direction. The guide bearing 112 is attached to the outer peripheral surface of the holder 102, and slidably interfits with a first guide groove 100e of the chamber 100.

### First Magnet Coupling 104 of Fourth Optical Component 38

The first magnet coupling 104 is connected to the holder 102. The first magnet coupling 104 has a rectangular shape, which extends in the Z axis direction, and slidably fits into a second guide groove 100e of the chamber 100. The first magnet coupling 104 includes a non-magnetic substrate 104a which is attached to the outer peripheral surface of the holder 102, and a magnet 104b which is attached to the outer surface of the substrate 104a. In the magnet 104b, the N-pole and S-pole are alternately magnetized in the Z axis direction. In the magnet 104b, a plurality of magnets may be aligned in the Z axis direction.

### Second Magnet Coupling of Fourth Optical Component 38

The second magnet coupling is disposed outside the chamber 100, and interlocks with the first magnet coupling 104. The second magnet coupling is cylindrical and is housed in the non-magnetic housing 106 so as to be rotatable around the shaft line Ax, which extends in the X axis direction. The N-pole and S-pole of the magnet of the second magnet coupling are alternately disposed in the circumferential direction. The housing 106 is attached to the outer peripheral surface of the chamber 100, and a partition member (not illustrated) is disposed between the housing 106 and the chamber 100. This partition member prevents entry of foreign substances or the like to the chamber 100.

### Drive Shaft 108 of Fourth Optical Component 38

The drive shaft 108 is connected to the second magnet coupling. The drive shaft 108 may include a motor (e.g. pulse motor) that rotates the drive shaft 108, although this is not illustrated. The drive shaft 108 may be rotated manually around the shaft line Ax. The drive shaft 108 is made of a non-magnetic material.

In the fourth optical component 38, the second magnet coupling which is connected to the drive shaft 108 is rotated around the shaft line Ax by the drive shaft 108 rotating around the shaft line Ax. Then the first magnet coupling 104 moves in the Z axis direction by attraction/repulsion between the magnet of the second magnet coupling and the magnet 104b of the first magnet coupling 104. Thereby the holder 102 which is connected to the first magnet coupling 104, and the optical element 110 which is held by the holder 102, move in the Z axis direction. As a result, a position in the Z axis direction of the focal point of the laser beam LB, which enters from the first end 100a of the chamber 100 and is emitted from the second end 100b, is adjusted. In other words, in the fourth optical component 38, even if the optical element 110 is isolated from the external environment by the chamber 100, the focal point of the laser beam LB can be adjusted by rotating the drive shaft 108 and moving the optical element 110 up/down thereby.

As illustrated in FIG. 2, in the laser irradiation assembly 6 configured as described above, the beam diameter of the laser beam LB, oscillated by the laser oscillator 30 along the Y axis direction, is adjusted first by the first optical component 32 (beam expander), then the output of the laser beam LB is adjusted by the attenuator 34, including the second optical component 62. The optical axis of the laser beam LB, of which output was adjusted, is converted from the Y axis direction to the X axis direction by the first third optical component 36 (angle adjuster), and is then converted from the X axis direction to the Z axis direction of the next third optical component 36 (angle adjuster). The laser beam LB, of which optical axis was converted to the Z axis direction, is then condensed by the fourth optical component 38 (condenser), and is applied onto a workpiece held on the workpiece holder 4.

### X-Axis Stage Drive 8 of Laser Processing Apparatus 2

As illustrated in FIG. 1, the X-axis stage drive 8 includes a ball screw 114 which is connected to the X axis movable plate 14 and extends in the X axis direction, and a motor 116 which rotates the ball screw 114. The X-axis stage drive 8 converts the rotary motion of the motor 116 to linear motion using the ball screw 114, then transfers the liner motion to the X axis movable plate 14, and moves the X axis movable plate 14 in the X axis direction along the guide rail 12a on the base 12. Thereby the chuck table 22 of the workpiece holder 4 is fed for processing in the X axis direction with respect to the fourth optical component 38 (condenser).

### Y-Axis Stage Drive 10 of Laser Processing Apparatus 2

The Y-axis stage drive 10 includes a ball screw 118 which is connected to the Y axis movable plate 16 and extends in the Y axis direction, and a motor 120 which rotates the ball screw 118. The Y-axis stage drive 10 converts the rotary motion of the motor 120 to linear motion using the ball screw 118, then transfers the linear motion to the Y axis movable plate 16, and moves the Y axis movable plate 16 in the Y axis direction along the guide rail 14a on the X axis movable plate 14. Thereby the chuck table 22 of the workpiece holder 4 is fed for processing in the Y axis direction with respect to the fourth optical component 38 (condenser).

### Workpiece

FIG. 1 also illustrates a disc-shaped wafer 122, which is a workpiece to be processed by the laser processing apparatus 2. The wafer 122 is made of a semiconductor material (e.g. silicon), for example. A front face 122a of the wafer 122 is sectioned into a plurality of rectangular regions by lattice-like division lines 124. On each of the plurality of rectangular regions, a device 126 (e.g. IC, LSI) is formed. The wafer 122 is supported by an annular frame 130 via a tape 128. In the example in FIG. 1, a rear face 122b of the wafer 122 is adhered to the tape 128, but the front face 122a of the wafer 122 may be adhered to the tape 128.

### Laser Processing Method

A preferred embodiment of the laser processing method according to the present disclosure will be described next.

### Preparing

In this embodiment, the laser processing apparatus 2 described above is prepared first.

### Holding

After performing the preparing, holding of the wafer 122 on the workpiece holder 4 is performed. In the holding, the wafer 122 is placed on the upper face of the chuck table 22 of the workpiece holder 4. Then a suction force to the suction chuck 24 is generated by the suction unit, so as to hold the wafer 122 on the upper face of the chuck table 22 by suction. Further, the annular frame 130 is fixed using a plurality of clamps 26.

### Laser Processing

After performing the holding, laser processing of applying the laser beam LB onto the wafer 122 held on the workpiece holder 4 and dividing the wafer 122 into individual chips is performed. In the laser processing, the focal point of the laser beam LB is positioned at the division line 124 of the wafer 122. Here the wafer 122 is imaged by the imaging unit 40, and the chuck table 22 is appropriately rotated based on the image of the wafer 122 captured by the imaging unit 40, whereby the division line 124 of the wafer 122 is aligned in the X axis direction. Then the focal point of the laser beam LB is positioned at the division line 124 aligned with the X axis direction. The position of the focal point in the vertical direction may be arbitrary.

Once the focal point of the laser beam LB is positioned at a predetermined position in the laser processing, the laser beam LB is applied onto the wafer 122 along the division line 124 to perform laser processing. For example, while feeding the chuck table 22 in the X direction for processing, the laser beam LB, having a wavelength which is transmissive to the wafer 122, is applied onto the wafer 122 from the fourth optical component 38 (condenser), whereby the start point of division can be formed inside the division line 124. Alternately, while feeding the chuck table 22 in the X direction for processing, the laser beam LB, having a wavelength, which is absorbable to the wafer 122, may be applied onto the wafer 122 from the fourth optical component 38 (condenser), whereby abrasion processing is performed along the division line 124, and a division groove is formed thereby. Then while indexing and feeding the chuck table 22 in the Y axis direction for the amount of the interval of the division lines 124 in the Y axis direction, the laser beam LB is repeatedly applied, until the laser processing is performed for all the division lines 124 aligned in the X axis direction. Then the chuck table 22 is rotated 90°, and the applying of the laser beam LB and the indexing and feeding are alternately repeated until the laser processing is performed for all the division lines 124 intersecting orthogonally with the above mentioned laser processed division lines 124. In the case of forming the start points of division, an external force is applied to the wafer 122, then the wafer 122 can be divided into individual chips along the start points of the division.

As described above, in the laser irradiation assembly 6 of this embodiment, the optical elements 58, 74, 96 and 110 of the first to fourth optical components 32, 62, 36 and 38 and the lens 48d are isolated from the external environment by the chambers 48, 64, 86 and 100. The laser light source of the laser oscillator 30 is also isolated from the external environment by the chamber 44. Therefore according to the laser processing apparatus 2, the adhesion of contaminants to the optical elements 58, 74, 96 and 110 and the lens 48d can be prevented, and the problem of a drop in performance of the optical elements 58, 74, 96 and 110 and the lens 48d can be solved. Since there is no problem of a drop in performance of the optical elements 58, 74, 96 and 110 and the lens 48d, the laser processing apparatus 2 of this embodiment can have a long service life with rare malfunctions.

According to the laser processing method of this embodiment, the laser processing apparatus 2 is used, hence optical elements 58, 74, 96 and 110 and the lens 48d are isolated from the external environment, and the adhesion of contaminants to the optical elements 58, 74, 96 and 110 and the lens 48d can be prevented. Therefore the wafer 122 can be stably processed without the problem of a drop in performance of the optical elements 58, 74, 96 and 110 and the lens 48d. Further, the laser processing apparatus 2 can have a long service life with rare malfunctions, which can reduce the unit cost of the chip.

It is preferable that inside the chambers 48, 64, 86 and 100 of the first to fourth optical components 32, 62, 36 and 38, inside the chamber 44 of the laser oscillator 30, and inside the chamber 84 of the additional optical component 63 are filled with dry air or inert gas (e.g. nitrogen gas) at a slightly higher pressure than atmosphere, since this prevents entry of foreign substances to the first to fourth optical components 32, 62, 36 and 38 even more efficiently. In this case, a communication hole (not illustrated), which communicates through the inside of the chambers, is disposed as a supply port (not illustrated), which is connected to a supply unit to supply the dry air or inert gas. When the dry air or inert gas is supplied from the supply port, the dry air or inert gas spread through the inside of the chamber via the communication hole.

It is also preferable that the inside of the chambers 48, 64, 86 and 100 of the first to fourth optical components 32, 62, 36 and 38, inside the chamber 44 of the laser oscillator 30, and inside the chamber 84 of the additional optical component 63 may be decompressed down to substantially be a vacuum state. If inside the chamber is substantially a vacuum state, a block of the laser beam LB inside the chamber can be prevented. In this case, a communication hole (not illustrated), which communicates inside the chambers is disposed, and a suction port (not illustrated), which is connected to the suction unit, is disposed on any one of the above chambers. When the suction unit is activated, inside the chambers is decompressed through the suction port and the communication hole.

The configuration of the laser irradiation assembly 6 is not limited to the above mentioned configuration. For example, the second optical component 62, which has a ¼ wave plate as the optical element 74, may be disposed on the downstream side of the attenuator 34 (between the third optical component 36 as the first angle adjuster and the third optical component 36 as the next angle adjuster). Thereby a linearly polarized laser beam LB (P-polarized light component) emitted from the attenuator 34 is converted to a circularly-polarized light by the ¼ wave plate. If the laser beam LB is converted to the circularly-polarized light, the influence of the polarization plane on the laser processing can be reduced.

### Reference Signs List

2 Laser processing apparatus
4 Workpiece holder
6 Laser irradiation assembly
8 X-axis stage drive
10 Y-axis stage drive
32 First optical component
34 Attenuator
36 Third optical component
38 Fourth optical component
48 Chamber
48a First end
48b Second end
48c Connecting portion
50 Holder
52 First magnet coupling
56 Drive shaft
58 Optical element
62 Second optical component
64 Chamber
64a First end
64b Second end
64c Connecting portion
66 Holder
68 First magnet coupling
70 Second magnet coupling
72 Drive shaft
74 Optical element
86 Chamber
86a Upper chamber
86b Lower chamber
86c First end
86d Second end
86e Connecting portion
88 Holder
90 First magnet coupling
94 Drive shaft
96 Optical element
100 Chamber
100a First end
100b Second end
100c Connecting portion
102 Holder
104 First magnet coupling
108 Drive shaft
110 Optical element

What is claimed is:

1. A laser processing apparatus comprising:
a workpiece holder that holds a workpiece;
a laser irradiation assembly including a condenser applying a laser beam onto the workpiece held on the workpiece holder;
an X-axis stage drive that moves the workpiece holder and the condenser relatively to implement processing in an X axis direction; and
a Y-axis stage drive that moves the workpiece holder and the condenser relatively to implement processing in a Y axis direction, which orthogonally intersects with the X axis direction, wherein the laser irradiation assembly includes an optical component including:
a chamber which is made of non-magnetic material, constituted of a first end that receives light and a second end that emits light;
a holder which holds an optical element to be housed in the chamber;
a first magnet coupling which is connected to the holder;
a second magnet coupling which is disposed outside the chamber and interlocks with the first magnet coupling; and
a drive shaft which is connected to the second magnet coupling, and
the optical element is driven by rotation of the drive shaft.

2. The laser processing apparatus of claim 1, wherein the drive shaft includes a motor.

3. The laser processing apparatus of claim 1, wherein
the non-magnetic material includes aluminum, stainless steel, copper, brass, resin, glass or ceramics.

4. The laser processing apparatus of claim 1, wherein
an inside the chamber is filled with dry air or inert gas containing nitrogen gas, or is decompressed.

5. The laser processing apparatus of claim 1, wherein
each of the first end and the second end of the chamber includes a connecting portion so as to be connected to each other.

6. A laser processing method for dividing a wafer, which is a workpiece, into individual chips, the method comprising:
preparing the laser processing apparatus of claim 1;
causing a workpiece holder to hold the wafer; and
laser processing of dividing the wafer into individual chips by applying a laser beam onto the wafer held on the workpiece holder.
